(19) United States
(12) Patent Application Publication
(10) Pub. No.: US 2011/0316986 A1
(43) Pub. Date: Dec. 29, 2011

(54) VIDEO DISPLAY APPARATUS AND VIDEO DISPLAY METHOD

(75) Inventor: Shogo MATSUBARA, Tokyo (JP)

(73) Assignee: Kabushiki Kaisha Toshiba, Tokyo (JP)

(21) Appl. No.: 13/085,206

(22) Filed: Apr. 12, 2011

(30) Foreign Application Priority Data
Jun. 23, 2010 (JP) 2010-143179

(51) Int. Cl. H04N 13/04

(52) U.S. Cl. 348/51; 348/E13.075

(57) ABSTRACT

According to one embodiment, a video display apparatus is provided. The video display apparatus includes: a margin generating module which adds a peripheral margin to an input first 3D image signal for generating a 3D image in a case where the first 3D image signal has no peripheral margin; and a 3D image generating module which compensates for a second 3D image signal in the margin, generates the 3D image based on the first and second 3D image signals, and outputs the 3D image to a video display unit.

### CROSS REFERENCE TO RELATED APPLICATION(S)

The application is based upon and claims the benefit of priority from Japanese Patent Application No. 2010-143179 filed on Jun. 23, 2010; the entire content of which are incorporated herein by reference.

### FIELD

The present disclosure relates to a video display apparatus and a video display method for displaying a 3D image.

### BACKGROUND

Currently, there is a video display apparatus which allows a viewer to view 3D video by displaying, on the display screen, a 3D image in which a parallax exists between a right-eye image and a left-eye image. The video display apparatus operates in combination with a 3D image selecting module such as special glasses which causes only the right-eye image of the 3D image to reach the right eye of the viewer and causes only the left-eye image to reach the left eye of the viewer.

For example, JP-A-2005-252459 discloses a technique characterized in outputting a stereographic pair of images, that is, a right eye image and a left-eye image that are disposed on the right side and the left side, respectively, in view of the fact that unnatural video is produced in such a manner that two images that are slightly deviated from each other are displayed alternately when a 3D image that complies with the parallax division method is displayed as it is.

However, particularly in 3D display using a 3D image whose image is formed at a position that is spaced forward from the display screen, when a figure is located close to the frame of the display screen, one of a right-eye image and a left-eye image of the figure cannot be displayed to break down 3D video. In this case, the range in which 3D display using a 3D image is limited with respect to a size of the display screen.

Although it is desired to solve the problem of a failure of 3D video of a 3D image formed on the display screen of a video display apparatus which displays a 3D image, no module for satisfying that desire is known.

### BRIEF DESCRIPTION OF THE DRAWINGS

FIG. 1 is a view showing an appearance of a digital TV broadcast receiver 111 according to exemplary embodiments and showing a network system centered by the digital TV broadcast receiver 111.

FIG. 2 is a block diagram showing a main part of a signal processing system of the digital TV broadcast receiver 111.

FIG. 3 is a block diagram showing a configuration of a video display apparatus according to a first embodiment.

FIG. 4 is a view showing an operation of the video display apparatus according to the first embodiment.

FIG. 5 is a block diagram showing a configuration of a video display apparatus according to a second embodiment.

FIG. 6 is a block diagram showing a configuration of a video display apparatus according to a third embodiment.

FIG. 7 is a block diagram showing a configuration of a video display apparatus according to a fourth embodiment.

FIG. 8 is a block diagram showing a configuration of a conventional video display apparatus.

FIG. 9 is a view illustrating a problem of the conventional video display apparatus.

### DETAILED DESCRIPTION

In general, according to one exemplary embodiment, a video display apparatus is provided. The video display apparatus includes: a margin generating module which adds a peripheral margin to an input first 3D image signal for generating a 3D image in a case where the first 3D image signal has no peripheral margin; and a 3D image generating module which compensates for a second 3D image signal in the margin, generates the 3D image based on the first and second 3D image signals, and outputs the 3D image to a video display unit.

Exemplary embodiments will be described below.

### First Embodiment

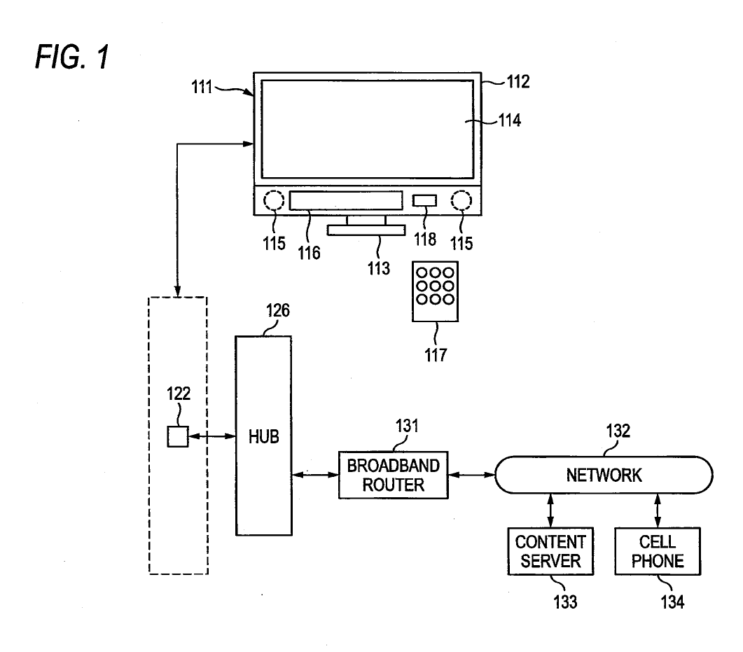

A first embodiment will be hereinafter described with reference to FIGS. 1-4, 8, and 9.

FIG. 1 is a view showing an appearance of a digital TV broadcast receiver 111 as a video display apparatus according to the embodiment and showing an example network system centered by the digital TV broadcast receiver 111.

The digital TV broadcast receiver 111 is mainly provided with a thin cabinet 112 and a support stage 113 for supporting the cabinet 112 which is erected. The cabinet 112 is provided with a flat panel video display 114 such as a liquid crystal display panel, speakers 115, a user interface 116, a light receiver 118 for receiving operation information that is transmitted from a remote controller 117, and other units.

The digital TV broadcast receiver 111 is also provided with a local area network (LAN) terminal 122. The LAN terminal 122 is connected to a network 132 such as the Internet via a broadband router 131 which is connected to a hub 126, and is used for exchanging information with a content server 133, a cell phone 134, or the like over the network 132.

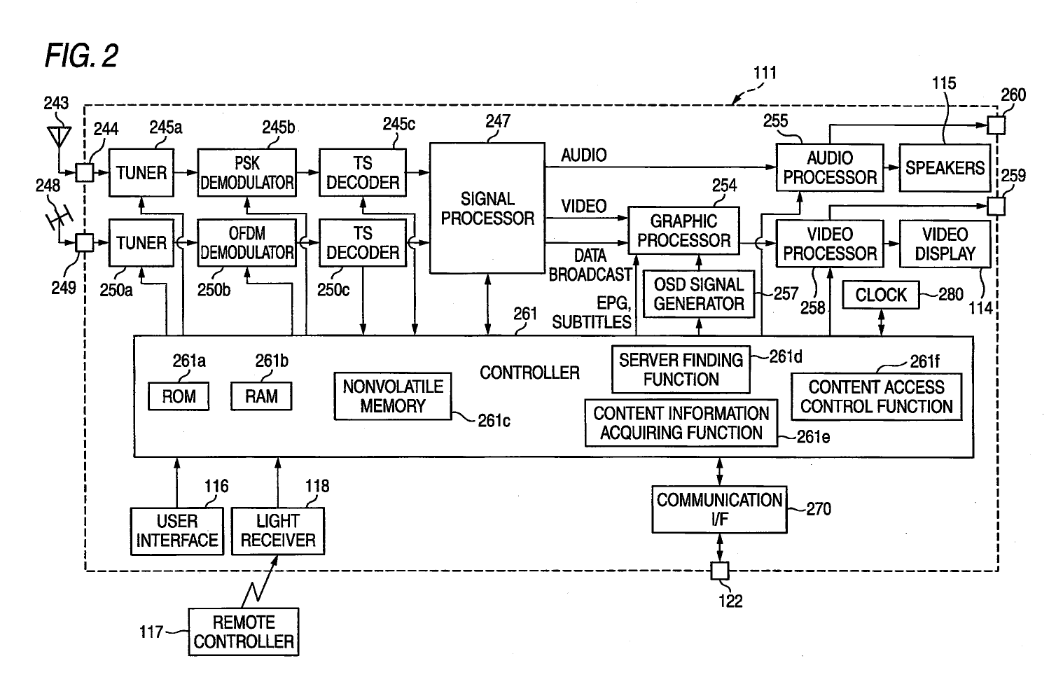

FIG. 2 is a block diagram showing a main part of a signal processing system of the digital TV broadcast receiver 111.

Satellite digital TV broadcast signals received by a BS/CS digital broadcast receiving antenna 243 are supplied to a satellite digital broadcast tuner 245a via an input terminal 244.

The tuner 245a tunes in to a broadcast signal on a desired channel according to a control signal supplied from a controller 261 and supplies the thus-selected broadcast signal to a phase shift keying (PSK) demodulator 245b.

The PSK demodulator 245b demodulates, according to a control signal supplied from the controller 261, the broadcast signal selected by the tuner 245a into a transport stream (TS) containing a desired program and supplies the transport stream to a TS decoder 245c.

The TS decoder 245c performs TS decoding on the TS-multiplexed signal according to a control signal supplied from the controller 261 and thereby depacketizes the TS signal into a digital video signal and a digital audio signal of the desired program, and outputs resulting packetized elementary streams (PESs) to an STD buffer 247f provided in a signal processor 247.

Furthermore, the TS decoder 245c outputs, to a section processor 247h provided in the signal processor 247, section information that is transmitted by the digital broadcast.

Terrestrial digital TV broadcast signals received by a terrestrial broadcast receiving antenna 248 are supplied to a terrestrial digital broadcast tuner 250a via an input terminal 249.

The tuner 250a tunes in to a broadcast signal on a desired channel according to a control signal supplied from the controller 261 and supplies the thus-selected broadcast signal to an orthogonal frequency division multiplexing (OFDM) demodulator 250b.

The OFDM demodulator 250b demodulates, according to a control signal supplied from the controller 261, the broadcast signal selected by the tuner 250a into a transport stream containing a desired program and supplies the transport stream to a TS decoder 250c.

The TS decoder 250c performs TS decoding on the TS-multiplexed signal according to a control signal supplied from the controller 261 and thereby depacketizes the TS signal into a digital video signal and a digital audio signal of the desired program, and outputs resulting packetized elementary streams (PESs) to the STD buffer 247f provided in the signal processor 247.

Furthermore, the TS decoder 250c outputs, to the section processor 247h provided in the signal processor 247, section information that is transmitted by the digital broadcast.

While a TV broadcast is being viewed, the signal processor 247 selectively performs pieces of a signal processing on sets of a digital video signal and a digital audio signal that are supplied from the TS decoders 245c and 250c, respectively, and outputs a resulting video signal and audio signal to a graphic processor 254 and an audio processor 255, respectively. During content replaying, the signal processor 247 selects a content replaying signal that is input from the controller 261, performs a digital signal processing on the content replaying signal, and outputs a resulting video signal and audio signal to the graphic processor 254 and the audio processor 255, respectively.

Various data for acquiring a program, electronic program guide (EPG) information, program attribute information (program genre etc.), and subtitle information etc. (service information (SI), or program specific information (PSI)) are input to the controller 261 from the signal processor 247.

The controller 261 performs image generation processing for displaying an EPG or subtitles based on these kinds of received information, and outputs generated image information to the graphic processor 254.

The section processor 247h outputs, to the controller 261, various data for receiving a program, electronic program guide (EPG) information, program attribute information (program genre etc.), and subtitle information (SI, PSI, etc.) which are part of section information that is input from the TS decoder 245c or 250c.

The graphic processor 254 has a function of combining (1) a digital video signal that is supplied from an AV decoder 247g provided in the signal processor 247, (2) an on-screen display (OSD) signal generated by an OSD signal generator 257, (3) image data of a data broadcast, and (4) an EPG or a subtitle signal generated by the controller 261 and outputting a resulting signal to a video processor 258.

In displaying subtitles of a subtitle broadcast, the graphic processor 254 performs processing of superimposing, on a video signal, subtitle information that is supplied from the controller 261.

The digital video signal that is output from the graphic processor 254 is supplied to the video processor 258. The video processor 258 converts the received digital video signal into an analog video signal having such a format as to be displayable by the video display 114. The analog video signal is output to and displayed by the video display 114 and also output to the outside via an output terminal 259.

The audio processor 255 converts the received digital audio signal into an analog audio signal having such a format as to be replayable by the speakers 115. The analog audio signal is output to and replayed as a sound by the speakers 115 and also output to the outside via an output terminal 260.

The controller 261 supervises all operations of the digital TV broadcast receiver 111 including various receiving operations described above. Incorporating a central processing unit (CPU) etc., the controller 261 receives operation information that is supplied from the user interface 116 or transmitted from the remote controller 117 and received by the light receiver 118 and controls the individual units so as to reflect the content of the operation.

In this case, the controller 261 mainly uses a read-only memory (ROM) 261a which is stored with control programs to be run by the CPU, a random access memory (RAM) 261b for providing a work area for the CPU, and a nonvolatile memory 261c which is stored with various kinds of setting information, control information, etc.

Furthermore, the controller 261 is connected to the LAN terminal 122 via a communication interface (I/F) 270. The controller 261 can thus exchange information, via the communication I/F 270, with each apparatus connected to the LAN terminal 122 (see FIG. 1).

A configuration of a conventional video display apparatus will now be described. As shown in FIG. 8, the conventional video display apparatus is composed of a video display unit 102 and a 3D image generating module 101 for generating a 3D image according to a display method of the video display unit 102. The video display unit 102 displays a 3D image outputted from the 3D image generating module 101 and allows a viewer to view 3D image by operating in combination with a 3D image selecting module which causes only a right-eye image of the 3D image to reach the right eye of the viewer and causes only a left-eye image of the 3D image to reach the left-eye of the viewer. For example, the 3D image selecting module may be glasses such as circularly polarization glasses in which a right-eye lens and a left-eye lens transmit circularly polarized light beams having different rotation directions or liquid crystal shutter glasses in which a right-eye lens and a left-eye lens are alternately rendered in a transparent state or an opaque state. The 3D image generating module 101 generates a 3D image that is suitable for the video display unit 102 which operates in combination with the 3D image selecting module. For example, the 3D image generating module 101 arranges a right-eye image and a left-eye image side by side according to the arrangement of circularly polarizing sheets stuck to the front surface of the video display unit 102. In the case of the liquid crystal shutter type, the shutters are synchronized with display. The video display apparatus needs to output a signal for the synchronization.

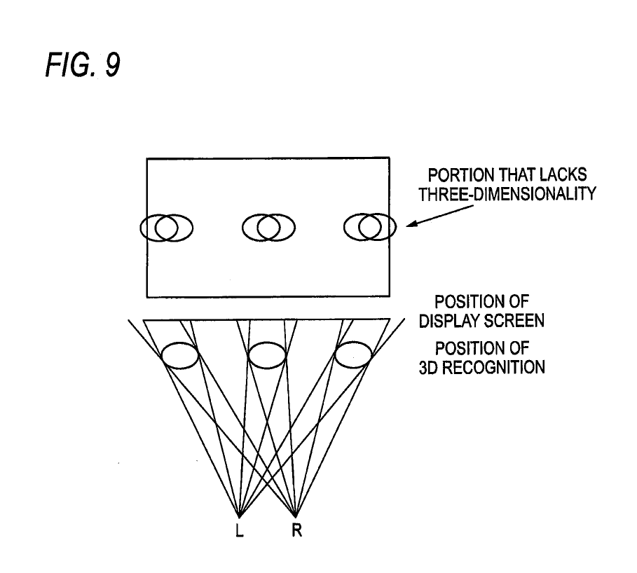

The problem of the conventional video display apparatus will be described below. As shown in FIG. 9, in the conventional video display apparatus, in 3D display using a 3D image whose image is formed at a position that is spaced forward from the display screen, one of a right-eye image and a left-eye image of a figure cannot be displayed and 3D video fails when the figure is located close to the frame of the display screen. This leads to a problem that the range of 3D display using a 3D image is limited with respect to a size of the display screen, that is, the range is smaller than the size of the display screen. Particularly in video taken with a rightward or leftward pan, a figure to be viewed three-dimensionally suddenly loses its three-dimensionality at a screen end, which affects not only 3D vision but also eye fatigue.

In view of the above, the embodiment provides video display apparatus which solves the problem of the replay of the range of 3D display using a 3D image by setting an image frame that is smaller than the display screen and generating a 3D image so that a 3D image can be displayed even outside the image frame. The video display apparatus will be described below.

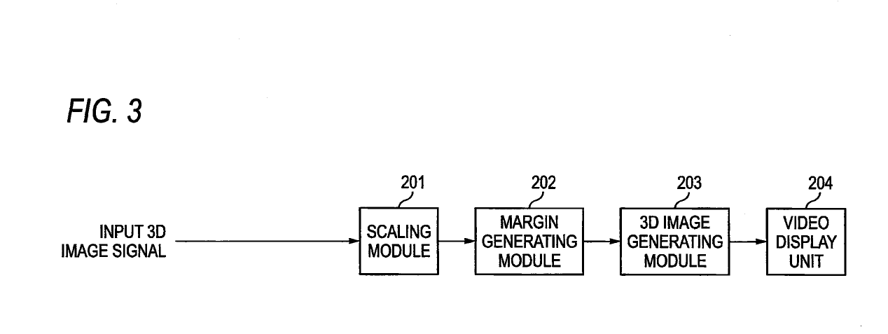

A video display apparatus according to the first embodiment will be described below. As shown in FIG. 3, the video display apparatus includes a scaling module 201 for converting an input 3D image signal into an image signal having a desired size, a margin generating module 202 for adding a peripheral margin to the size-converted image signal, a 3D image generating module 203 for generating a 3D image based on an output of the margin generating module 202, and a video display unit 204 for displaying the thus-generated 3D image. The input 3D image signal contains a 2D image signal and a parallax signal. The scaling module 201, the margin generating module 202, and the 3D image generating module 203 correspond to the video processor 258 which operates under the control of the controller 261 (see FIG. 2). The video display unit 204 corresponds to the video display 114.

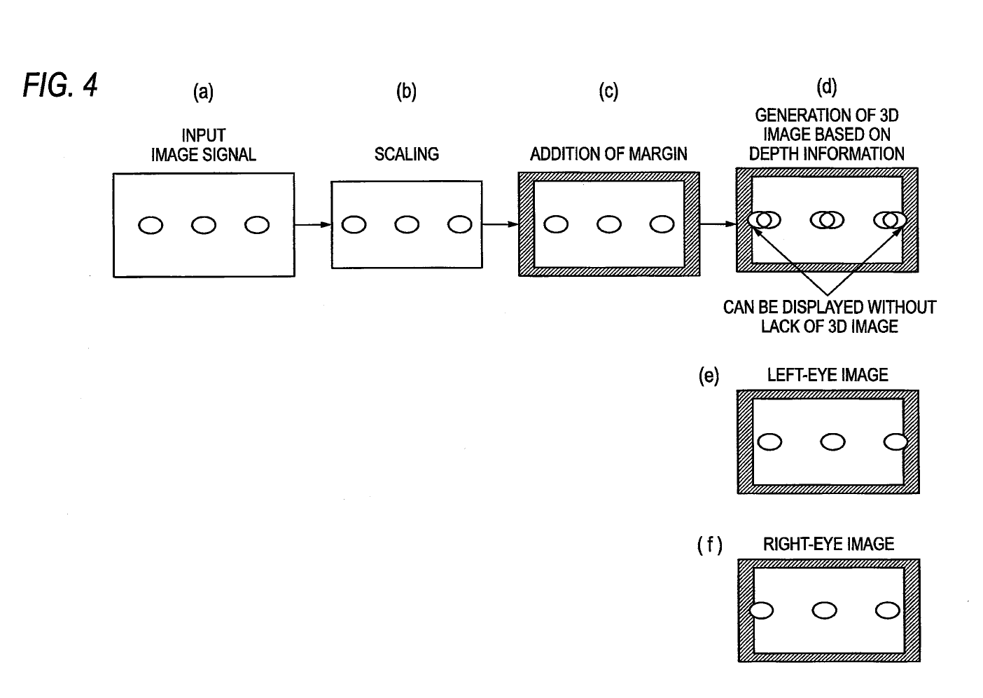

The operation of the configuration of FIG. 3 will be described below also with reference to FIG. 4. First, the scaling module 201 performs scaling into such a size that blanks are formed at the right end and the left end inside the display screen, the width of the blanks being equal to a maximum parallax interval to be formed on the display screen (a transition is made from the state of part (a) of FIG. 4 to the state of part (b)). The parallax needs to be decreased according to the degree of the scaling. Then, the margin generating module 202 adds a peripheral margin to a size-converted image signal and thereby generates an image having the same size as the display screen (a transition is made to the state of part (c) of FIG. 4). An output of the margin generating module 202 is input to the 3D image generating module 203, which makes the margin a non-parallax area and generates a 3D image that is suitable for a display method of the video display unit 204 based on depth information contained in the received 3D image signal (a transition is made to the state of part (d) of FIG. 4). The generated 3D image is displayed by the video display unit 204.

According to the first embodiment, an image frame that is smaller than the display screen is set in advance and hence a 3D figure can also be generated outside the image frame. As a result, even in the case where one of a right-eye image and a left-eye image might be lost at a screen end in a 3D-viewable 3D image corresponding to an input 3D image signal, three-dimensionality is not lost there. The problem of the conventional video display apparatus that the range for 3D display using a 3D image is made smaller than the size of the display screen is thus solved.

### Second Embodiment

Next, a second embodiment will be described with reference to FIGS. 1, 2, and 5. Sections, units, modules, etc. having the same ones in the first embodiment will not be described in detail.

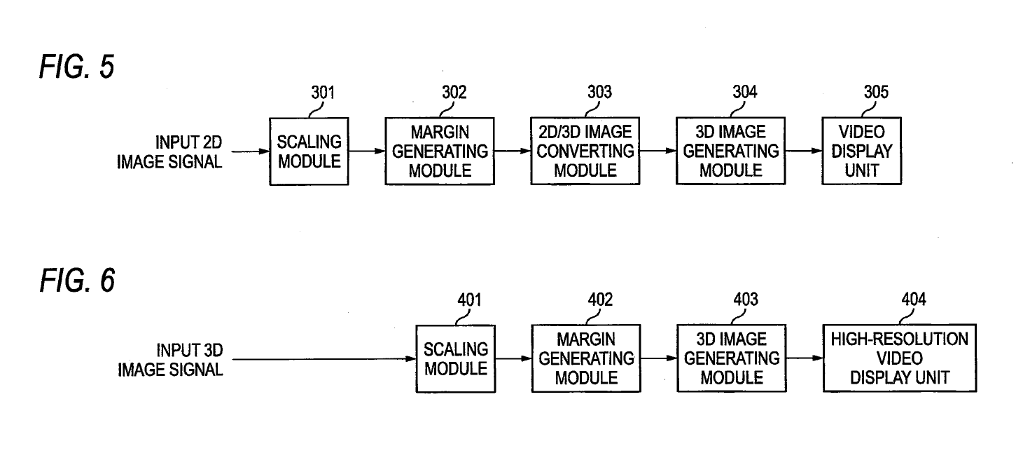

A video display apparatus according to the second embodiment will be described below with reference to FIG. 5. As shown in FIG. 5, the video display apparatus includes a scaling module 301 for converting an input 2D image signal into an image signal having a desired size, a margin generating module 302 for adding a peripheral margin to the size-converted image signal, a 2D/3D image converting module 303 for generating a 3D image signal based on an output 2D image signal of the margin generating module 302, a 3D image generating module 304 for generating a 3D image based on the generated 3D image signal according to a display method of a video display unit 305, and the video display unit 305 for displaying the thus-generated 3D image.

The operation of the second embodiment shown in FIG. 5 will be described below. As in the first embodiment, an input 2D image signal is subjected to scaling and addition of a margin. An output of the margin generating module 302 is input to the 2D/3D image converting module 303, which generates a 3D image signal for 3D viewing by, for example, calculating depth information through pattern matching using image motion information or image features. In calculating depth information, the margin is dealt with as a non-parallax area. The generated 3D image signal is input to the 3D image generating module 304, which generates, based on the depth information contained in the 3D image signal, a 3D image that is suitable for the video display unit 305 which operates in combination with the 3D image selecting module (described above). The generated 3D image is displayed by the video display unit 305. The configuration of the second embodiment which includes the 2D/3D image converting module 303 provides the same advantage as the first embodiment does.

### Third Embodiment

Next, a third embodiment will be described with reference to FIGS. 1, 2, and 6. Sections, units, modules, etc. having the same ones in the first or second embodiment will not be described in detail.

A video display apparatus according to the third embodiment will be described with reference to FIG. 6. As shown in FIG. 6, the video display apparatus includes a scaling module 401 for converting an input 3D image signal into an image signal having a desired size, a margin generating module 402 for adding a peripheral margin to the size-converted image signal, a 3D image generating module 403 for generating a 3D image based on an output of the margin generating module 402, and a high-resolution video display unit 404 for displaying the thus-generated 3D image. The high-resolution video display unit 404 has a higher resolution than the input image signal.

The third embodiment is different from the first embodiment in that the former is provided with the high-resolution video display unit 404. When the scaling module reduces the image in order to enable addition of a margin, deterioration in resolution may be caused in the image by the reduction scaling. However, in the third embodiment, since the high-resolution video display unit 404 displays the image, an additional advantage that the reduction scaling does not result in reduction in resolution and the viewer can enjoy higher resolution video is obtained, in addition to the advantage that the problem that the range in which 3D display using a 3D image is possible is made smaller than the size of the display screen is solved.

### Fourth Embodiment

Next, a fourth embodiment will be described with reference to FIGS. 1, 2, and 7. Sections, units, modules, etc. having the same ones in the first, second, or third embodiment will not be described in detail.

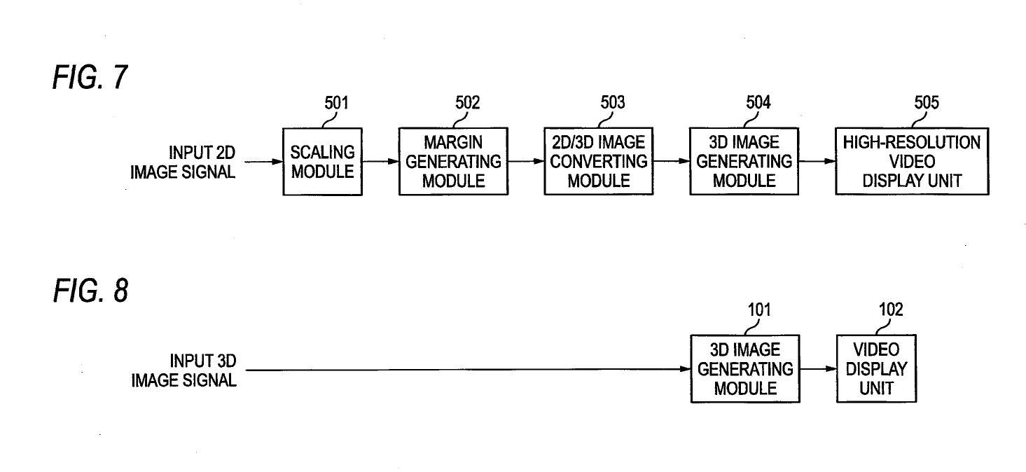

A video display apparatus according to the fourth embodiment will be described below with reference to FIG. 7. As shown in FIG. 7, the video display apparatus includes a scaling module 501 for converting an input 2D image signal into an image signal having a desired size, a margin generating module 502 for adding a peripheral margin to the size-converted image signal, a 2D/3D image converting module 503 for generating a 3D image signal based on an output 2D image signal of the margin generating module 502, a 3D image generating module 504 for generating a 3D image based on the generated 3D image signal according to a display method of a high-resolution video display unit 505, and the high-resolution video display unit 505 for displaying the thus-generated 3D image. The high-resolution video display unit 505 has a higher resolution than the input image signal. The operation of the fourth embodiment is the same as that of the second embodiment except a difference that results from the use of the high-resolution video display unit 505. In addition to the advantage of solving the problem that the range of 3D display using a 3D image is limited, an additional advantage that the reduction scaling does not result in reduction in resolution and the viewer can enjoy higher resolution video is obtained by the use of the high-resolution video display unit 505.

As a modification to each of the first to fourth embodiments, it is possible to set the scaling result size and the size and the display content of the margin arbitrarily.

There are video display apparatus which allow a viewer to view 3D video by displaying, on the display screen, a 3D image in which a parallax exists between a right-eye image and a left-eye image. These video display apparatus operate in combination with a 3D image selecting module which causes only the right-eye image of the 3D image to reach the right eye of the viewer and causes only the left-eye image to reach the left eye of the viewer. However, in conventional video display apparatus, in 3D display using a 3D image whose image is formed at a position that is spaced forward from the display screen, when a figure is located close to the frame of the display screen, one of a right-eye image and a left-eye image of the figure cannot be displayed to break down 3D video. This leads to a problem that the range in which 3D display using a 3D image is possible is made smaller than the display screen.

In view of the above, in the embodiments, an image frame that is smaller than the display screen is set and a 3D image is generated so that a 3D image can be displayed even outside the image frame. This solves the problem of the reduction of the range of 3D display using a 3D image. Furthermore, the use of the high-resolution video display unit having a higher resolution than an input image signal prevents reduction in resolution due to an image size change and allows the user to enjoy higher resolution video.

The embodiments are summarized as follows:

(1) A video display apparatus comprising: a scaling module for converting an input 3D image signal into an image signal having a desired size; a margin generating module for adding a peripheral margin to the size-converted image signal; a 3D image generating module for making the margin a non-parallax area and generating a 3D image according to a display method of a video display unit based on an output of the margin generating module; and the video display unit for displaying the generated 3D image.

(2) The video display apparatus according to item (1), wherein the input 3D image signal contains a 2D image signal and depth information.

(3) A video display apparatus comprising: a scaling module for converting an input 2D image signal into an image signal having a desired size; a margin generating module for adding a peripheral margin to the size-converted image signal; a 2D/3D image converting module for making the margin a non-parallax area and generating a 3D image signal based on an output of the margin generating module; a 3D image generating module for generating a 3D image based on the generated 3D image signal according to a display method of a video display unit; and the video display unit for displaying the generated 3D image.

(4) A video display apparatus comprising: a scaling module for converting an input 3D image signal into an image signal having a desired size; a margin generating module for adding a peripheral margin to the size-converted image signal; a 3D image generating module for making the margin a non-parallax area and generating a 3D image based on an output of the margin generating module according to a display method of a video display unit; and the high-resolution video display unit having a higher resolution than the input image signal, for displaying the generated 3D image.

(5) A video display apparatus comprising: a scaling module for converting an input 2D image signal into an image signal having a desired size; a margin generating module for adding a peripheral margin to the size-converted image signal; a 2D/3D image converting module for making the margin a non-parallax area and generating a 3D image signal based on an output of the margin generating module; a 3D image generating module for generating a 3D image based on the generated 3D image signal according to a display method of a high-resolution video display unit; and the high-resolution video display unit having a higher resolution than the input image signal, for displaying the generated 3D image.

The invention is not limited to the above embodiments, and can be practiced so as to be modified in various manners without departing from the spirit and scope of the invention. For example, a margin need not always be added. If areas (black bands or parts of a picture-frame-like area) where no video is displayed in the case of 2D display exist at the right end and left end of the screen depending on the manner of a pan, a right-eye or left-eye image signal may be displayed there in the case of 3D display without reducing the image size.

While certain embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display apparatus comprising:
a margin generating module configured to add a peripheral margin to an input first 3D image signal for generating a 3D image in a case where the first 3D image signal has no peripheral margin; and
a 3D image generating module configured to compensate for a second 3D image signal in the margin, to generate the 3D image based on the first and second 3D image signals, and to output the 3D image to a video display unit.

2. The apparatus of claim 1 further comprising:
a 2D/3D image converting module configured to convert a 2D image signal into the first 3D image signal, wherein
the margin generating module is configured to output the 2D image signal to the 2D/3D image converting module.

3. A video display apparatus comprising:
a margin generating module configured to add a peripheral margin to an input 2D image signal;
a 2D/3D image converting module configured to convert the 2D image signal output from the margin generating module into a first 3D image signal for generating a 3D image; and
a 3D image generating module configured to compensate for a second 3D image signal in the margin using the first 3D image signal, to generate the 3D image based on the first and second 3D image signals, and to output the 3D image to a video display unit.

4. The apparatus of claim 1 further comprising the video display unit.

5. The apparatus of claim 2 further comprising the video display unit.

6. The apparatus of claim 3 further comprising the video display unit.

7. The apparatus of claim 4, wherein the video display unit has a higher resolution than a resolution of one of the first 3D image signal and the 2D image signal.

8. The apparatus of claim 5, wherein the video display unit has a higher resolution than a resolution of one of the first 3D image signal and the 2D image signal.

9. The apparatus of claim 6, wherein the video display unit has a higher resolution than a resolution of one of the first 3D image signal and the 2D image signal.

10. A video display method comprising:
adding a peripheral margin to an input first 3D image signal for generating a 3D image;
compensating for a second 3D image signal in the margin;
generating the 3D image based on the first and second 3D image signals; and
outputting the 3D image to a video display unit.
